(19) United States
(12) Patent Application Publication
(10) Pub. No.: US 2005/0256748 A1
(43) Pub. Date: Nov. 17, 2005

(54) Method of managing a life insurance policy and a system therefor

(76) Inventors: Adrian Gore, Gauteng (ZA); Kenneth Steven Rabson, Johannesburg (ZA); Herschel Phillip Mayers, Johannesburg (ZA)

Correspondence Address: MARSHALL & MELHORN, FOUR SEAGATE, EIGHT FLOOR, TOLEDO, OH, 43604, US

(21) Appl. No.: 11/097,947

(22) Filed: Apr. 1, 2005

(30) Foreign Application Priority Data
Apr. 1, 2004 (ZA) 2004/2587

(51) Int. Cl. G06F 17/60

(52) U.S. Cl. 705/4

(57) ABSTRACT

The invention relates to a method of managing a life insurance policy in which the life insurer receives a premium from an insured life and wherein if the insured life suffers an insured event, the life insurer pays a predetermined sum assured to the insured life or a beneficiary nominated by the insured life. The method includes defining a retirement age and when the insured life reaches the retirement age, paying at least one payment from the life insurer to the insured life. After the at least one payment the sum assured is reduced so that the amount which will be paid to the insured life or their nominated beneficiary in the event of them suffering an insured event in the future is reduced.

### BACKGROUND OF THE INVENTION

This invention relates to a method of managing a life insurance policy and to a system therefor.

Typical life insurance policies operate in that an insured life pays a premium to the life insurer and a payout is made to the insured life or their beneficiaries upon the insured life suffering a disability, contracting a dread disease or dying. The payout on these contingencies is collectively termed as risk benefits.

It will be appreciated that although such policies cover many of the life changing events the insured life may experience, they do not cover one major event, namely, retirement.

It is an object of the present invention to address this.

### SUMMARY OF THE INVENTION

This invention relates to a method of managing a life insurance policy, in which the life insurer receives a premium from an insured life and wherein if the insured life suffers an insured event, the life insurer pays a predetermined sum assured to the insured life or a beneficiary nominated by the insured life, the improvement comprising:
defining a retirement age; and
when the insured life reaches the retirement age, paying at least one payment from the life insurer to the insured life.

In one embodiment, after the at least one payment the sum assured is reduced so that the amount which will be paid to the insured life or their nominated beneficiary in the event of them suffering an insured event in the future is reduced.

Preferably, the reduction of the sum assured is equivalent to the at least one payment made to the insured life.

The retirement age may be any one of 50, 55, 60, 65 or 70 or any other age between 50 and 70.

Preferably, when the insured life reaches retirement age, periodic payments are made from the life insurer to the insured life.

In addition to this, the insured life may receive a lump sum payout at retirement.

The invention further relates to a electronic system for managing a life insurance policy, in which the life insurer receives a premium from an insured life and wherein if the insured life suffers an insured event, the life insurer pays a predetermined sum assured to the insured life or a beneficiary nominated by the insured life, the system including:
a memory for storing:
   information relating to the insured life;
   information relating to a predefined retirement age of the insured life;
   information relating to a sum assured; and
a processor disposed in communication with the memory, the processor being adapted to:
   when the insured life reaches the retirement age, pay at least one payment from the life insurer to the insured life.

The processor may further be adapted to after the at least one payment, reduce the sum assured so that the amount which will be paid to the insured life or their nominated beneficiary in the event of them suffering an insured event in the future is reduced.

The processor may further be adapted to reduce the sum assured by an amount which is equivalent to the at least one payment made to the insured life.

The processor may in addition be further adapted to make periodic payments from the life insurer to the insured life when the insured life reaches retirement age.

The processor may also further be adapted to make a lump sum payout to the insured life at retirement.

### BRIEF DESCRIPTION OF THE DRAWINGS

FIG. 1 illustrates graphically the operation of an example of the present invention; and

FIG. 2 is a schematic system diagram of one embodiment of the present invention.

### DESCRIPTION OF AN EMBODIMENT

The aim of the present invention is to provide a life insurance policyholder, being the insured life, with guaranteed income during retirement by allowing them to redeem a portion of their sum assured as income on a regular basis. The policyholder can elect to have each redemption payment reduce the size of the sum assured and all risk benefits will reduce accordingly.

Thus, the insured life defines a retirement age and when the insured life reaches the retirement age, periodic payments are made from the life insurer to the insured life and wherein after each periodic payment the amount of the sum assured and hence the cover available for risk benefits is reduced.

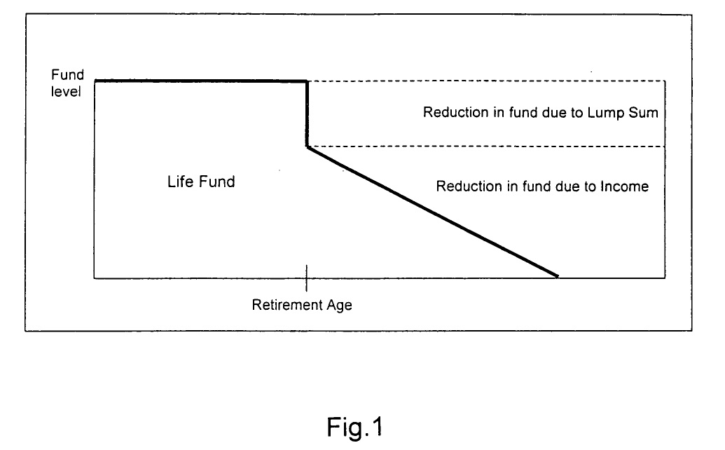

In addition, the insured life can select an option whereby they receive a lump sum payment at retirement, which is equivalent to a predetermined portion of the sum assured. This can be set at one third of the value of the sum assured, for example. The above is graphically illustrated in FIG. 1.

The amount of the sum assured will escalate by an interest percentage, typically linked to the consumer price index (CPI), for example.

In terms of the present invention, the insured life selects various options regarding the income that they wish to receive in retirement.

Firstly, the insured life nominates a percentage of the sum assured that they will receive as income. The income will then be calculated on the percentage of the sum assured at retirement age after deducting the lump-sum payment.

The retirement income will grow in line with a chosen escalation rate. Typically, the insured life will be provided with the option to escalate income based on one of CPI, 50% of CPI or no escalation, for example.

In addition, the insured life can select the payment frequency and can select between receiving income on a monthly or annual basis, for example.

The policy holder can choose benefit payment period (i.e. the time over which the income will be paid), namely 10 years, 20 years or whole of life, for example.

Once the income commences, the income amount will not be dependent on the size of the sum assured and will be paid until the end of the chosen benefit payment period even if the sum assured has dropped to zero. This is applicable to all the benefit payment periods

Further to this is to also present an invention to provide a life insurance policyholder, being the insured life, with guaranteed fund at retirement that he can use to buy a range of annuities with. This will provide him with an income during retirement. These income amounts will be offset against the policy holder's sum assured and all risk benefits will reduce accordingly.

Thus, the insured life defines a retirement age and also the size of the monthly contribution. When the insured life reaches the retirement age a guaranteed retirement fund will be available which will be used to provide, periodic payments to the insured life through the purchase of an annuity and wherein after each periodic payment the amount of the sum assured and hence the cover available for risk benefits is reduced.

In addition, the insured life can select an option whereby they receive a lump sum payment at retirement from the guaranteed retirement fund, which is equivalent to a portion of the guaranteed retirement fund.

This annuity will provide a retirement income, payable on a chosen frequency and/or monthly or annually. The income payments will grow in line with a chosen escalation rate. The annuity offered will provide the policyholder with the option to escalate income based on one of CPI, 50% of CPI or no escalation or a fixed income escalation, for example.

The insured life is able to select their retirement age that may be one of 50, 55, 60, 65 or 70 or any age between 50 and 70, for example.

There will be a prerequisite that the insured life must be a member of the life insurance policy for a minimum period such as 10 years, for example, between the date of taking out the policy and the chosen retirement age.

In one embodiment, the premium is divided into two portions, one for the risk part of the life policy and the second being for the retirement part of the life policy. The retirement portion could also include the premium saving as a result of the reducing sum assured. The premiums for this benefit can be in the form of a once off single premium or in the form of regular premiums.

In the case of making regular premium payments, the premiums for the risk part of the life policy will be payable over the lifetime of the policy with the premiums for the retirement aspect only being payable up to retirement age.

It is also possible to escalate the premiums for the retirement part of the policy at a different rate than the premiums for the risk part of the policy. Again, the insured life can be given a choice of premium escalation patterns such as CPI or CPI plus two % or an additional percentage that changes over age, for example.

The insured life can also be given tax structure options for countries where retirement policies and life insurance policies are taxed at different rates.

If the insured life selects a retirement policy tax structure, the policy can be adjusted to comply with retirement funding regulations whereas if the policy holder selects a life insurance policy tax structure, the policy will be adjusted to comply with life insurance policy regulations. The tax implications of this will differ from country to country.

It will be appreciated that one aspect of the uniqueness of the invention lies in the fact that the insured life uses at least a portion of their sum assured to provide their retirement benefits. A traditional retirement product provides retirement benefits based on the accumulation of premiums with investment returns. This effectively means that the level of retirement income will fluctuate with investment returns and is never known until retirement age is actually reached. However, under the present invention there is no direct link between premiums paid and the retirement benefits as the benefits for a defined premium is guaranteed. In addition, in terms of the present invention, the insured life does not bear any investment risk which is in contrast to traditional retirement funding where the insured life bears all the risk of poor investment returns. Thus, this invention provides guaranteed retirement income for a guaranteed premium.

The following features and options are used to enhance the retirement benefits payable:

Income Enhancement on Disability and/or Severe Illness

The benefit will provide additional income should the insured life suffer a severe illness or disability and is a standard product feature. The amount of additional income and the term of paying the income amount will depend on the severity level of the incident. The enhanced income payments will not reduce the sum assured.

Death Benefits

If the insured life dies before the retirement age, an income will be payable to their beneficiaries from the date of death. Alternatively a lump sum will be paid to the beneficiaries at the time of death. The benefit on death, be it a lump sum or an income will be dependent on the past premiums that were paid; accumulated at inflation, for example.

The income payments are guaranteed to be paid to the insured life for at least 5 years from retirement age even if the insured life dies within 5 years after retirement, for example. The insured life can choose to extend this guaranteed income term to 10 years for an additional premium, for example.

Spouse's Pension on Death

The spouse's pension pays an income to the spouse upon the insured life dying during the benefit payment term. The spouse's pension commences upon the later of the insured life's death, and the expiry of the guaranteed income term. The spouse's pension is payable until the earlier of the end of the chosen benefit payment period and the spouse's death, but it is subject to a minimum of 5 years and a maximum of 15 years, for example. The spouse's pension is chosen by the insured life. It is for example allowed to be either:
50% of principal income
100% of principal income
   Lapse Benefit Prior to Retirement Age

If the insured life stops paying premiums before retirement age, an income will be payable to him from the original chosen retirement age. The policyholder can also elect to take a lump sum at the time of lapsing.

The benefit on lapsing be it a lump sum or an income will be dependent on the past premiums that were paid; accumulated at inflation, for example.

Protecting the Sum Assured from Reducing Due to Income Payments

The insured life can elect at retirement for the income payments not to reduce their sum assured. Under this option the sum assured will only start reducing with income payments and the lump at an elected age after retirement. The size of that reduction need not be exactly equal to the actual income and lump sum payments and can be some multiple of it.

Minimum Protected Fund to Protect Fund Against Risk Claims (MPF)

The insured life can choose to protect their risk cover from claims on risk benefits. Under this option, the risk sum assured will be restored back to the protected level after a risk claim.

Bonus Lump Sum Linked to Investment Performance

The insured life can choose to receive bonus retirement benefits where the amount of the bonus is linked to the performance of a global investment index or a local index or any other investment portfolio. Thus, the retirement lump sum and/or the retirement income will be increased by this bonus. These bonus retirement benefits will not reduce the sum assured.

Bonus Lump Sum Linked to Health Claims, Credit Card Spend or Any Other Loyalty Program

The insured life can choose to receive bonus retirement benefits where the amount of the bonus is linked to his health claims, credit card spend or the performance of the policyholder or his family on any other loyalty program. Thus, the retirement lump sum and/or the retirement income will be increased by this bonus. These bonus retirement benefits will not reduce the sum assured.

Ill-Health Retirement

The insured life may choose to retire earlier than the chosen retirement age due to ill health. They will receive an income based on the past premiums that were paid; accumulated at inflation, for example. sum assured adjusted for the fact that the benefit is paid out earlier than the chosen retirement age. The earliest age from which ill-health retirement is allowed is age 55, for example.

Waiver of Premium

The insured life may elect to have their premiums waived on their entire policy should they suffer a disability or severe illness. Under this benefit, the life insurer will pay their premiums while in claim, but the premium increases covered are subject to a maximum of 20% per annum, for example:

The client will have the choice whether they want the waiver to cover:
a) only the premiums on their risk benefits; OR
b) only the premiums on their retirement benefits; OR
c) both the premiums on their risk and their retirement benefits

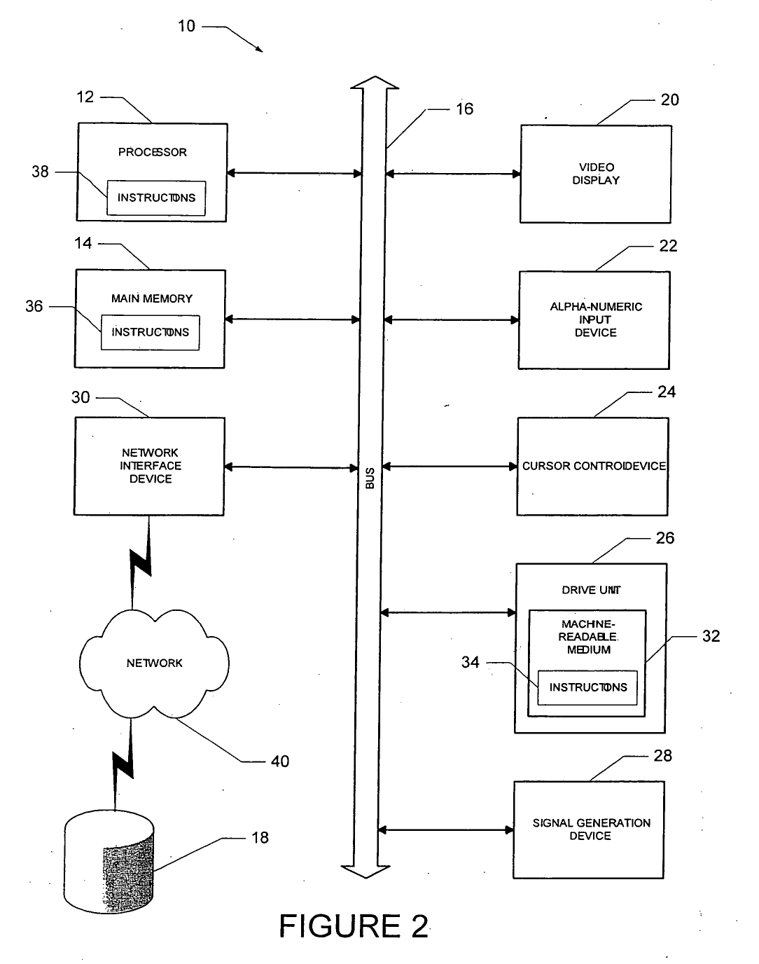

FIG. 2 shows a diagrammatic representation of one example of an electronic system for implementing the above methodology. In one exemplary form the electronic system is a machine in the form of a computer system 10 within which a set of instructions, for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a web appliance, a network router, switch or bridge, or any machine capable of executing a set of instructions (sequential or otherwise) that specify actions to be taken by that machine.

Further, while only a single machine is illustrated, the term “machine” shall also be taken to include any collection of machines that individually or jointly execute a set (or multiple sets) of instructions to perform any one or more of the methodologies discussed herein.

The exemplary computer system 10 includes a processor 12 (e.g., a central processing unit (CPU) a graphics processing unit (GPU) or both) and a memory 14.

The memory 14 is used for storing at least information relating to the insured life, information relating to a predefined retirement age of the insured life and information relating to a sum assured.

In another embodiment the memory may be in the form of a database 18 in which case the database will be used for storing information relating to relating to the insured life, information relating to a predefined retirement age of the insured life and information relating to a sum assured.

The processor 12 is in communication with the memory 14 via bus 16. The processor is adapted to pay at least one payment from the life insurer to the insured life when the insured life reaches the retirement age and after the at least one payment, to reduce the sum assured so that the amount which will be paid to the insured life or their nominated beneficiary in the event of them suffering an insured event in the future is reduced.

The processor 12 is further adapted to reduce the sum assured by an amount which is equivalent to the at least one payment made to the insured life.

The electronic system 10 may further include a video display unit 20 (e.g., a liquid crystal display (LCD) or a cathode ray tube (CRT)), an alphanumeric input device 22 (e.g., a keyboard), a cursor control device 24 (e.g., a mouse), a disk drive unit 26, a signal generation device 28 (e.g., a speaker) and a network interface device 30 to connect to a network 40.

The disk drive unit 26 includes a machine-readable medium 32 on which is stored one or more sets of instructions (e.g., software 34) embodying any one or more of the methodologies or functions described herein.

While the machine-readable medium 32 is shown to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

The processor 12 is further adapted to make periodic payments from the life insurer to the insured life when the insured life reaches retirement age.

Finally, the processor 12 is further adapted processor to make a lump sum payout to the insured life at retirement.

1. A method of managing a life insurance policy, in which the life insurer receives a premium from an insured life and wherein if the insured life suffers an insured event, the life insurer pays a predetermined sum assured to the insured life or a beneficiary nominated by the insured life, the method including:
defining a retirement age; and
when the insured life reaches the retirement age, paying at least one payment from the life insurer to the insured life.

2. A method according to claim 1 wherein after the at least one payment the sum assured is reduced so that the amount which will be paid to the insured life or their nominated beneficiary in the event of them suffering an insured event in the future is reduced.

3. A method according to claim 2 wherein the reduction of the sum assured is equivalent to the at least one payment made to the insured life.

4. A method according to claim 1 wherein the retirement age is one of 50, 55, 60, 65 or 70 or any age between 50 and 70.

5. A method according to claim 1 wherein when the insured life reaches retirement age, periodic payments are made from the life insurer to the insured life.

6. A method according to claim 1 wherein the insured life receives a lump sum payout at retirement.

7. An electronic system for managing a life insurance policy, in which the life insurer receives a premium from an insured life and wherein if the insured life suffers an insured event, the life insurer pays a predetermined sum assured to the insured life or a beneficiary nominated by the insured life, the system including:
a memory for storing:
information relating to the insured life;
information relating to a predefined retirement age of the insured life; and
information relating to a sum assured; and
a processor disposed in communication with the memory, the processor being adapted to:
when the insured life reaches the retirement age, pay at least one payment from the life insurer to the insured life;

8. An electronic system according to claim 7 wherein the processor is further adapted to after the at least one payment, reduce the sum assured so that the amount which will be paid to the insured life or their nominated beneficiary in the event of them suffering an insured event in the future is reduced.

9. An electronic system according to claim 8 wherein the processor is further adapted to reduce the sum assured by an amount which is equivalent to the at least one payment made to the insured life.

10. An electronic system according to claim 7 wherein the processor is further adapted to make periodic payments from the life insurer to the insured life when the insured life reaches retirement age.

11. An electronic system according to any one of claim 7 wherein the processor is further adapted to make a lump sum payout to the insured life at retirement.
